(19) United States
(12) Patent Application Publication
(10) Pub. No.: US 2025/0379989 A1
(43) Pub. Date: Dec. 11, 2025

(54) CONCATENATION OF VIDEO DATA WITH SELECTIVE TRANSCODING

(71) Applicant: NVIDIA Corporation, Santa Clara, CA (US)

(72) Inventors: Ronak SHAH, Ahmedabad (IN); Rahul BHAGWAT, Pune (IN)

(73) Assignee: NVIDIA Corporation, Santa Clara, CA (US)

(21) Appl. No.: 18/736,970

(22) Filed: Jun. 7, 2024

(51) Int. Cl. H04N 19/172; H04N 19/132; H04N 19/177; H04N 21/234

(52) U.S. Cl. CPC H04N 19/172; H04N 19/132; H04N 19/177; H04N 21/23424

(57) ABSTRACT

In various examples, systems and methods are disclosed relating to accurately extracting requested portions of video data by concatenating video data with selective transcoding. The systems can receive a request indicating a start position and an end position and select a video data element including the start position. The systems can decode a portion of the video data element including the start position and encode a subset of a plurality of first frames of the video data element to provide a first video output. The systems can combine the first video output with a second video output that includes one or more second frames of the video data up until the end position.

### BACKGROUND

Video management systems can capture images and/or video of scenes. The captured information can be provided for use by applications, analytics, or presentation to users. However, it can be difficult to provide such video information efficiently and accurately, due to factors including the manner in which video data is structured and hardware resource requirements for accurately extracting requested portions of video data.

### SUMMARY

Implementations of the present disclosure relate to concatenation of video data with selective transcoding. In contrast to conventional systems, such as those described above, systems and methods in accordance with the present disclosure can allow for providing accurate video data that starts at a requested start timestamp with a reduced use of hardware (e.g., reduced usage of a transcoder). For example, systems and methods in accordance with the present disclosure can decode and encode a portion of the video data including the start timestamp and append the remaining video data, without transcoding, until the end timestamp, to provide the requested video data more efficiently.

At least one aspect relates to one or more processors. The one or more processors can include one or more circuits. The one or more circuits can select, according to a request that indicates a start position and an end position for retrieval of video data, a video data element comprising the start position. The one or more circuits can encode, responsive to decoding a portion of the video data element that comprises the start position, a subset of a plurality of first frames of the video data element comprising (i) one of the plurality of first frames corresponding to the start position and (ii) each first frame of the plurality of first frames following the one of the plurality of first frames until a key frame of the video data element, to provide a first video output. The one or more circuits can combine the first video output with a second video output comprising one or more second frames of the video data up to the end position for the video data.

In some implementations, the one or more circuits can combine the first video output with the second video output by providing, to a multiplexer, the first video output the second video output without decoding the second video output. In some implementations, the key frame can be a second key frame, and the video data element can include a first key frame prior to the plurality of first frames, where the one or more circuits can skip encoding of each first frame of the plurality of first frames between the first key frame and the one of the plurality of first frames corresponding to the start position. The one or more circuits can encode the subset of the plurality of first frames according to one or more encoding parameters by which frames of the second video output are encoded. The one or mor circuits can discard from inclusion in the first video output and the second video output any one or more frames of the video data element subsequent to the end position.

In some implementations, the video data element includes a plurality of groups of pictures (GOPs), the plurality of first frames is of a first GOP of the plurality of GOPs, and the key frame is of a second GOP of the plurality of GOPs subsequent to the first GOP. In some implementations, the one or more processors can be included in at least one of a system for performing deep learning operations, a system for performing simulation operations, a system for performing collaborative content creation for 3D assets, a system for generating synthetic data, a system for performing digital twin operations, a control system for an autonomous or semi-autonomous machine, a perception system for an autonomous or semi-autonomous machine, a system incorporating one or more virtual machines (VMs), a system implemented using a robot, a system implemented using an edge device, a system comprising one or more vision language models (VLMs), a system comprising one or more large language models (LLMs), a system for performing conversational AI operations, a system for performing light transport simulation, a system implemented at least partially in a data center, or a system implemented at least partially using cloud computing resources.

At least one aspect relates to a system. The system can include one or more processing units and one or more memory units storing instructions that, when executed by the one or more processing units, cause the one or more units to execute operations. The operations can include selecting, according to a request that indicates a start position and an end position for retrieval of video data, a video data element comprising the start position. The operations can include encoding, responsive to decoding a portion of the video data element that comprises the start position, a subset of a plurality of first frames of the video data element comprising (i) one of the plurality of first frames corresponding to the start position and (ii) each first frame of the plurality of first frames following the one of the plurality of first frames until a key frame of the video data element, to provide a first video output. The operations can include combining the first video output with a second video output comprising one or more second frames of the video data up to the end position for the video data.

In some implementations, the one or more processors can combine the first video output with the second video output by providing, to a multiplexer the first video output the second video output without decoding the second video output. In some implementations, the key frame can be a second key frame, and the video data element can include a first key frame prior to the plurality of first frames, where the one or more processors can skip encoding of each first frame of the plurality of first frames between the first key frame and the one of the plurality of first frames corresponding to the start position. The one or more processors can encode the subset of the plurality of first frames according to one or more encoding parameters by which frames of the second video output are encoded. The one or more processors can discard from inclusion in the first video output and the second video output any one or more frames of the video data element subsequent to the end position.

In some implementations, the video data element includes a plurality of groups of pictures (GOPs), the plurality of first frames is of a first GOP of the plurality of GOPs, and the key frame is of a second GOP of the plurality of GOPs subsequent to the first GOP. In some implementations, the system is included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

At least one aspect relates to a method. The method can include selecting, according to a request that indicates a start position and an end position for retrieval of video data, a video data element comprising the start position. The method can include encoding, responsive to decoding a portion of the video data element that comprises the start position, a subset of a plurality of first frames of the video data element comprising (i) one of the plurality of first frames corresponding to the start position and (ii) each first frame of the plurality of first frames following the one of the plurality of first frames until a key frame of the video data element, to provide a first video output. The method can include combining the first video output with a second video output comprising one or more second frames of the video data up to the end position for the video data.

In some implementations, the first video output can be combined with the second video output by providing, to a multiplexer, the first video output and the second video output without decoding the second video output. In some implementations, the key frame can be a second key frame, and the video data element can include a first key frame prior to the plurality of first frames and encoding skips each first frame of the plurality of first frames between the first key frame and the one of the plurality of first frames corresponding to the start position. Encoding the subset of the plurality of first frames can be according to one or more encoding parameters by which frames of the second video output are encoded.

In some implementations, any one or more frames of the video data element subsequent to the end position in the first video output and the second video output can be discarded from inclusion in the first video output and the second video output. In some implementations, the video data element can include a plurality of groups of pictures (GOPs), the plurality of first frames is of a first GOP of the plurality of GOPs, and the key frame is of a second GOP of the plurality of GOPs subsequent to the first GOP.

### BRIEF DESCRIPTION OF THE DRAWINGS

The present systems and methods for concatenation of video data with selective transcoding are described in detail below with reference to the attached drawing figures, wherein:

FIG. 1 is a block diagram of an example of a video management system, in accordance with some implementations of the present disclosure;

FIG. 2 is a block diagram of a video transcoding process, in accordance with some implementations of the present disclosure;

FIG. 3 is a block diagram of an example method to concatenate video data with selective transcoding, in accordance with some implementations of the present disclosure;

FIG. 4 is a block diagram of an example method to concatenate video data with selective transcoding, in accordance with some implementations of the present disclosure;

FIG. 5 is a block diagram of an example content streaming system suitable for use in some implementations of the present disclosure;

FIG. 6 is a block diagram of an example computing device suitable for use in implementing some implementations of the present disclosure; and

FIG. 7 is a block diagram of an example data center suitable for use in implementing some implementations of the present disclosure.

### DETAILED DESCRIPTION

Systems and methods are disclosed related to concatenation of video data with selective transcoding, such as for partial transcoding of video data responsive to a request for selected video data. For example, systems and methods in accordance with the present disclosure can allow for parsing (e.g., seeking, reading, etc.) of the video data to determine frames corresponding to a requested start timestamp, responsive to which the system can transcode (e.g., decode and encode) a portion of the video data including the start timestamp. The remaining frames between the start timestamp and the end timestamp can then be combined with (e.g., multiplexed, appended, etc.) the transcoded portion of the video data.

Video management systems (VMSs) record image data from images captured by cameras to provide video data (e.g., video recordings). The video data can be recorded in small segments, e.g., one-minute segments. The video data can be requested for various tasks, such as processing by an analytics service, or presentation to a user. Since any given segment may not include all the video for a time period of video requested, the VMS can combine multiple segments, such as to provide a file of combined segments.

VMSs can output the video data by selecting segments that correspond to a timestamp (e.g., a start time) of a request for the video data. The task and/or user can expect that the video data starts with a frame of the timestamp, such as for proper/accurate processing of the video data. However, VMSs may not provide video data accurate to the requested timestamp, or may require significant computational resources to retrieve video data for which a start frame is accurate to the requested timestamp. For example, some VMSs search for a key frame prior to the start time represented by the timestamp, and provide video data starting with the key frame, which may thus have one or more extra frames before the actual time that is requested. Some VMSs use a decoder to process the video data in order to identify the image frame that corresponds to the timestamp, but the use of the decoder (and corresponding encoder/transcoding operations) can be hardware-intensive.

Systems and methods in accordance with the present disclosure can allow for accurate delivery of video data and can allow for such delivery with reduced hardware demands. For example, a system can receive a request to retrieve video data. The system can retrieve, from the request, a start position for the requested video data. The system can retrieve a segment of video data that has the start position, such as from a compressed video file and/or bitstream. The system can cause a decoder to decode the segment to retrieve a plurality of frames (e.g., video frames, image frames) from the segment, such as from a first key frame (e.g., IDR frame) at or prior to the start position to an end frame prior to a subsequent second key frame. The system can provide the plurality of retrieved frames to an encoder, which can encode a target frame of the plurality of retrieved frames that corresponds to the start position and can encode each retrieved frame following the target frame to the end frame. The system can generate output data that includes the encoded frames and includes one or more remaining frames from the second key frame to an earlier of a frame of an end position indicated in the request or a final frame of the segment. The output data (e.g., a file) can be provided to a component that requested the video data. These techniques can allow the system to be advantageously faster in providing the requested video data, as the use of transcoding can be selectively limited to the retrieved frames for decoding (e.g., decompressing) and encoding (e.g., the group of pictures (GOP) that has the start position), while remaining frames up to the end position are combined (e.g., appended, concatenated) to the transcoded frames without transcoding. For example, the system can transcode the image frames from the start position to a final image frame of a data segment (e.g., GOP) that includes the image frame corresponding to the start position, and can combine these transcoded image frames with any remaining image frames up to the end position (e.g., without transcoding the remaining images frames).

In some implementations, the system retrieves the video from a source file. The system can use a demultiplexer and/or a parser to parse the data and can perform the seek operation to look for the closest key frame before the requested start position, and can start pushing the data. The system can stop pushing the data once the requested end position is reached.

The system (e.g., using a GOP detector) can detect the GOP which has the requested start position, and can send bitstream data to the decoder till a GOP boundary is reached. For example, the GOP detector can stop pushing the data to the decoder once the next IDR frame is detected. Responsive to detection of the next IDR frame, the GOP detector can directly send data to multiplexer, e.g., to the multiplexer rather than to the decoder.

The decoder can start decoding from the IDR frame till the GOP boundary, and can push the data to the encoder from the accurate requested start position. The encoder can start encoding from the accurate requested start position. In some implementations, the encoder uses the same encoding parameters as the original file till the GOP boundary, which can allow for a smooth transition from the transcoded data to the data send directly to the multiplexer. The encoder can send the bitstream data to the multiplexer. The multiplexer can then combine, e.g., multiplex, the bitstream data into a container format, which can then be provided as output data to the requesting task (e.g., user request and/or video analytics service).

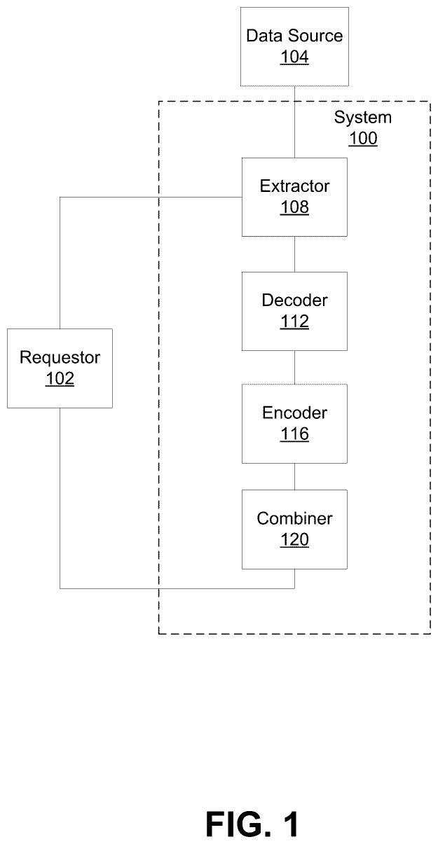

With reference to FIG. 1, FIG. 1 is an example system 100, in accordance with some implementations of the present disclosure. It should be understood that this and other arrangements described herein are set forth only as examples. Other arrangements and elements (and without limitation machines, interfaces, functions, orders, groupings of functions) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any hardware, function, model (e.g., machine learning model), operation, routine, logic, or instructions to perform functions such as partial and/or selective transcoding of video data, including to implement one or more of extractor 108, decoder 112, encoder 116, and/or combiner 120. The system 100 can include or be coupled with one or more components of a VMS, such as to provide video data in response to a request provided to the VMS.

The system 100 can include or be communicatively coupled with at least one of a requestor 102. The requestor 102 can include or be implemented by at least one of a client device or an application that processes data provided by the system 100. The client device can include, for example, a device of the VMS.

The requestor 102 can include services such as video analytics (e.g. and without limitation analyzing security camera footage, and vehicle license plate imaging). The requestor 102 can perform operations including downloading requested segments of video data as well as sending the requested video footage to, for example, a video analytics service. The system 100 can provide the requestor 102 with a video file based on a query of the requestor 102.

The requestor 102 can request video data (e.g. and without limitation the video file, a segment of the video footage). The requestor 102 can specify a start position (e.g., 1 minute, 1:30) and/or an end position (e.g., 2 minutes, 2:30). The requestor 102 can present a query to request the user to input the start position and/or the end position. The requestor 102 can be from and/or include any of a plurality of services (e.g. video analytics, a client).

The requestor 102 can output the requested video footage corresponding to the start position and the end position. The requestor 102 can output the video footage with the start position and the end position in a desired video format. The requestor 102 can present (e.g., show) the video footage to the user. The requestor 102 can receive input from the user (e.g., via the user interface) by which the user can manipulate (e.g., edit, input into another video software) the video footage provided by the requestor 102.

The system 100 can include or be coupled with at least one data source 104. The data sources 104 can be sources of image and/or video data to be provided to the requestor 102 in response to the request from the requestor 102. In some embodiments, the data sources 104 can include or be coupled with one or more cameras, such as video cameras (e.g., video cameras of a VMS), such that images and/or video data generated by the one or more cameras can be stored in the data source 104.

The data sources 104 can include any of various databases, data sets, or data repositories, for example. The data source 104 can be maintained by one or more entities, which may be entities that maintain the system 100 or may be separate from entities that maintain the system 100. In some implementations, the system 100 uses data from different data sets, such as by using data from a first data source 104 to retrieve video footage for a first request of the requestor 102, and from a second data source 104 to retrieve video footage for a second request of the requestor 102.

The data sources 104 can include, without limitation, data such as any one or more of text, speech, audio, image, and/or video data. The system 100 can perform various pre- processing operations on the data, such as filtering, normalizing, compression, decompression, upscaling or downscaling, cropping, and/or conversion to grayscale (e.g., from image and/or video data).

Images (including video) and/or image frames (or video frames) of the data source 104 can correspond to one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The data source 104 can include videos and/or video data structured as a plurality of frames (e.g. and without limitation image frames, video frames, key frames, interframes), such as in a sequence of frames, where each frame is assigned a time index (e.g. and without limitation timestamp, time step, time point) and has image data assigned to one or more pixels of the images. The video data can include resolution, audio tracks, metadata (e.g., creation date of the video), bitrate, and/or the aspect radio.

In some implementations, the image data and/or video data of the data source 104 include camera pose information. The camera pose information can indicate a point of view by which the data source 104 is represented. For example, the camera pose information can indicate at least one of a position or an orientation of a camera (e.g., real or virtual camera) by which the image and/or video data is captured or represented.

The data source 104 can include data from imaging cameras and/or video cameras. For example, the data source 104 can include, and without limitation, image and/or video data from security cameras, traffic cameras, and vehicle cameras.

For example, the video data of the data source 104 can include one or more video data segments (e.g., video data elements). Each video data segment can include a segment of video, such as video data from a first point in time (e.g., begin position) to a second point in time (e.g., stop position). As an example, the video data segments can have lengths in time of one minute. The data source 104 can include time information associated with respective video data segments, such as to include the first point in time and second point in time of a given video data segment. The video data segments can have lengths in time of one second and contain a portion of the video data. The video data segments can be independently decoded, encoded, and returned to the requestor 102.

The video data segment can include a plurality of frames. The frames can be arranged in one or more groups. For example, the frames can be arranged in groups of pictures (GOPs), where each GOP includes a plurality of corresponding frames. In some implementations, a first frame of the plurality of frames of a GOP is a key frame. The key frame can also be referred to as an intra-frame (I-frame or IDR frame). The key frame can include complete image data. For example, the key frame can be an independent frame whereas other frames (e.g., P-frames), rely on the independent frame and store changes from the key frame. The key frame can be a reference point for subsequent frames (e.g., P-frames) which store changes (e.g., differences) from the key frame. The GOP can include a first key frame and a second key frame. For example, a first boundary of the GOP can be the first key frame and a second boundary of the GOP can be the second key frame. In some implementations, the remaining frames of the plurality of frames of the GOP (e.g., between the first key frame and the second key frame) are inter-frames (e.g., P-frames). The P-frames can be predictive frames that stores changes from the previous key frame or P-frame. The P-frames can store less data due to relying on the previous key frame or P-frame. The P-frame can use motion vectors to describe and store the differences between a reference frame (e.g., the previous key frame or P-frame) and a current frame (e.g., the P-frame).

The video data segment can include a plurality of GOPs and the second key frame can be included in a second GOP of the plurality of GOPs subsequent to the first GOP. Each of a plurality of GOPs can correspond to one or more key frames of a plurality of key frames within the video data segment.

In some implementations, the inter-frames of the plurality of frames of the GOP also include bi-directional predictive frames (B-frames). The B-frames can use data from both preceding and following frames (e.g., key frames, P-frames, and/or B-frames). The B-frames can interpolate between the preceding and following frames using motion vectors.

Referring further to FIG. 1, each frame of the plurality of frames of the video data (e.g., of each video data segment) can be assigned respective time information. For example, each frame can be assigned a timestamp representing the time information for the frame, such as to indicate a time at which the frame was captured by a corresponding camera. The timestamp can be in a length of time of seconds.

The system 100 can include or be coupled at least one extractor 108. The extractor 108 can be used to retrieve selected data from the video data, such as to retrieve selected subsets (e.g., portions) of video and/or video frames. The extractor 108 can receive the request for video footage with the start position and the end position from the requestor 102. The extractor 108 can select a video data segment that includes the start position from the data source 104. In some embodiments, the extractor 108 can also select a video data segment that includes the end position from the data source 104, and any and all intermediary video data segments between the video data segment that includes the start position and the video data segment that includes the end position. The extractor 108 can extract the video footage and/or video data (e.g., bitstream) from the data source 104. The extractor 108 can drop frames from a video data segment that follow the requested end position.

The extractor 108 can include a parser. The parser can read and interpret (e.g., process) the structure (e.g., resolution) and the metadata of the video footage extracted from the data source 104. The parser can extract metadata from the requested video footage and organize the data to be processed by the system 100. The parser can read (e.g., parse) the video data and perform a seek operation to identify a key frame (e.g., the first key frame) that is closest to (but prior to or at) the requested start position of the requestor 102. The parser can begin pushing (e.g., extracting information from) the video data at the start position and stop pushing once the requested end position is reached.

The extractor 108 can include a demultiplexer (e.g., demuxer). The demuxer can separate information from the video footage such as the video data, audio, and subtitles. The demuxer can output separate streams of information (e.g., bitstreams). For example, the demuxer can output the video data as a first stream of information and the audio of the video footage as a second stream of information. For example, the demuxer can receive an MP4 video footage file, separate a H.264 video stream and an AAC audio stream, and send the streams to be decoded.

The parser can provide data and information to the demuxer. The parser can read, interpret, and extract metadata and structural information from the video footage while the demuxer can use information provided by the parser to separate and output bitstreams from the video footage to be processed by the decoder 112.

The system 100 can include or be coupled with at least one decoder, such as the decoder 112. The decoder 112 can decode the video data (e.g., compressed video data; bitstream) retrieved by the extractor 108, such as based on an encoding scheme of the video data. For example, the decoder 112 can receive the bitstreams extracted by the extractor 108. The extractor 108 can provide the decoder 112 with, and without limitation, compressed video data, motion vectors, reference frame indices, and frame timestamps in separate bitstreams. The decoder 112 can convert and/or transform compressed video data (e.g., video data encoded with codecs) into a format that can be processed by the requestor 102, such as a format of displaying video that can viewed by the user. The decoder 112 can decode (e.g., decompress) frames included in the GOP structure of the parsed bitstream. The decoder 112 may include, without limitation, any one or more of various types of video decoders (e.g., MPEG-4 Part 2, MPEG-4). The decoder 112 can apply reverse compression to the video data to reconstruct the frames for display. The decoder 112 can compensate for motion vectors used in P-frames, for example, to reconstruct the frame. The decoder 112 can perform entropy decoding, inverse quantization, inverse transformation, and/or motion compensation to reconstruct the frames of the video data. The decoder 112 can convert the bitstreams encoded in various formats to an acceptable format for the combiner 120.

The system 100 can provide the decoder 112 with the start position requested by the requestor 102. The decoder 112 can decode output of the extractor 108. For example, the decoder 112 can decode a portion of the video data segment that includes the start position. The decoder 112 can begin decoding from the first key frame within the portion of the video data segment that includes the start position.

The system 100 can include or be coupled with at least one encoder, such as the encoder 116. The encoder 116 can encode (e.g., compress) the video data, such as by using algorithms to reduce a file size of the video data. The encoder 116 can compress the bitstreams of the video data segment output by the decoder 112. The encoder 116 can use spatial compression to reduce redundancy between frames to reduce the file size. The encoder 116 can use temporal compression to reduce the file size. The encoder 116 can use motion estimation to encode motion vectors and reduce precision of the encoded video data.

The encoder 116 can encode the output of the decoder 112 according to one or more parameters of encoding of the video data from the data source 104 (e.g., of the video data retrieved by the extractor 108 to perform extraction). For example, the encoder 116 can use one or more of the same encoding parameters (e.g., resolution, video file format) as the video data stored by the data source 104. As described further herein, this can allow the system 100 to generate video to provide to the requestor 102 that smoothly transitions between video data that is processed by the decoder 112 and/or encoder 116 (e.g., video data that includes the start position) and video data that is not processed by the decoder 112 and/or encoder 116 (e.g., video data subsequent to a group of pictures (GOP) that includes the start position), such as where the system 100 performs selective transcoding.

In some implementations, the decoder 112 and/or encoder 116 form a part of at least one transcoder. The decoder 112 and/or encoder 116 can be implemented as hardware units and/or perform hardware-intensive operations. By selectively controlling video data to be processed by the decoder 112 and/or encoder 116, such as to perform selective transcoding, the system 100 can advantageously allow for reduced hardware resource usage while retaining accuracy in the output to be provided to the requestor 102. For example, as described below with reference to combiner 120, the system 100 can combine video data that is processed by the encoder 116 (e.g., video data in which the start position falls) with video data that is not processed by the encoder 116 (e.g., video data from one or more elements of video data, such as GOPs and/or segments, subsequent to the video data in which the start position falls, up to the end position) to provide an output that meets the criteria of the request from the requestor 102 and with reduced hardware usage.

Referring further to FIG. 1, the encoder 116 can encode a subset of a plurality of first frames of the video data segment. The plurality of first frames can include key frames and P-frames. The subset of the plurality of first frames of the video data element can include one of the plurality of first frames that corresponds to the start position and each first frame of the plurality of first frames following the one of the plurality of first frames until the next key frame of the video data segment. For example, the encoder 116 can encode a GOP including the first key frame that corresponds to the requested start position and can encode starting from the first key frame until the second boundary of the GOP is met (e.g., the second key frame). The encoder 116 can provide a first video output including the plurality of frames between the first key frame and the second key frame, where the first video output can include the start position.

In some implementations, the first key frame of the video data segment is prior to the requested starting position. In this case, the encoder 116 can skip encoding of each first frame of the plurality of first frames between the first key frame and the one of the plurality of first frames corresponding to the start position. The encoder 116 can encode starting from the first key frame to the second key frame.

The system 100 can include or be coupled with at least one combiner 120. The combiner 120 can combine video data from the encoder 116 with video data that is not processed by the decoder 112 and/or encoder 116, such as to generate a video data structure (e.g., file) having a consistent encoding format for use by the requestor 102.

The combiner 120 can include a multiplexer. The multiplexer can combine the bitstreams received from the encoder 116 into a single multiplexed stream of the requested video data segment. The multiplexer can use time division multiplexing (TDM) to retain timing information and time stamps of the video data segment. The multiplexer can combine (e.g., multiplex) the bitstream data received from the encoder 116 into a container format. The container format can synchronize the bitstreams in a single file. The container format can include MP4, MKV, and AVI. The multiplexer can perform a function opposite and/or reverse a function of the demultiplexer.

The combiner 120 can include a sink. The sink can generate a video data structure that includes the output of the multiplexer. For example, the sink can store (e.g., save) the output of the multiplexer into the single file. The sink can save the container format of the video data segment with the requested start position and the end position. The file can then be sent to the requestor 102.

The system 100 can generate a second video output which includes one or more second frames of the video data segment up to the requested end position of the video data. For example, the one or more second frames can include the frames between the second key frame and the frames corresponding to the requested end position. The combiner 120 can combine the first video output and the second video output and return the video output to the requestor 102. The first video output can be transcoded while the second video output can be appended (e.g., combined, multiplexed) to the first video output without transcoding. The first video output can be encoded according to encoding parameters of the second video output. The subset of the plurality of first frames can be encoded according to one or more encoding parameters by which frames of the second video output are encoded. The combiner 120 can discard from inclusion in the first video output and the second video output any one or more frames of the video data segment subsequent to the requested end position.

In some implementations, the requestor 102 may receive at least one of the start position or the end position. In this case, the extractor 108 can extract the video data segment with the start position responsive to the requestor 102 receiving the start position, or the extractor 108 can extract the video data segment with the end position responsive to the requestor 102 receiving the end position. For example, if the requestor 102 receives only the end position, the video data segment extracted by the extractor 108 can include a starting frame of the data source 104 (e.g., a segment of the video data) corresponding to the end position. If the requested end position is 1:00 and the video data segment corresponding to 1:00 is stored in a portion of the data source 104 corresponding to 0:30 to 2:30, the extractor 108 can extract the video data segment starting at 0:30 and ending with frames corresponding to 1:00.

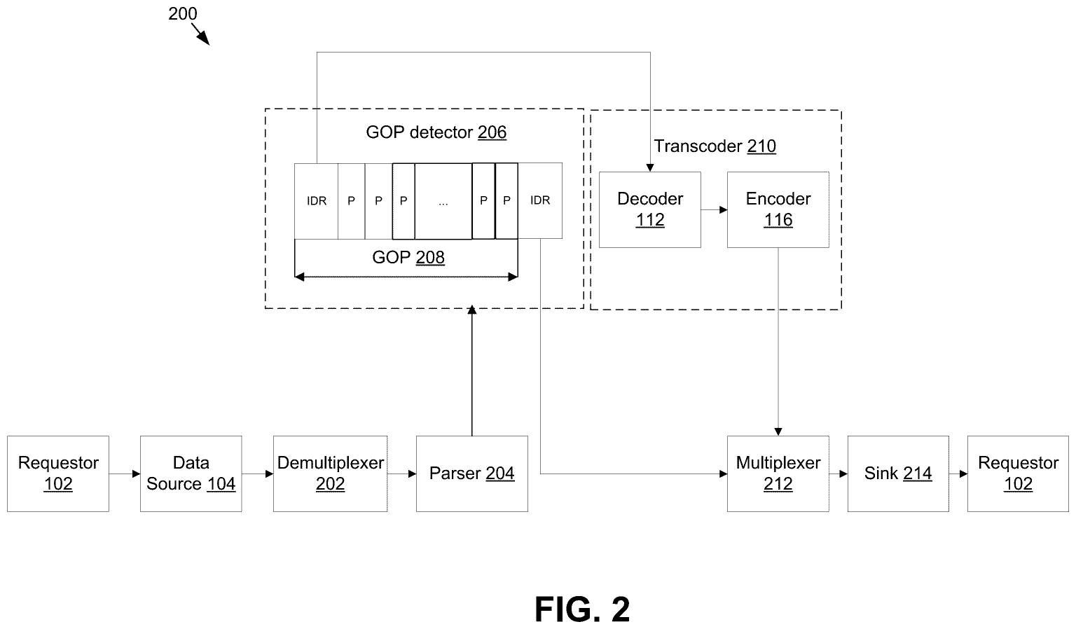

FIG. 2 is a block diagram of a system 200 in accordance with some implementations of the present disclosure. It should be understood that this and other arrangements described herein are set forth only as examples. Other arrangements and elements (e.g. and without limitation machines, interfaces, functions, orders, and groupings of functions) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 200 can include any hardware, function, model (e.g., machine learning model), operation, routine, logic, or instructions to perform functions such as partial and/or selective transcoding of video data, including to implement one or more of the requestor 102, the decoder 112, the encoder 116, a demultiplexer 202, a parser 204, a GOP detector 206, a multiplexer 212, and a sink 214. The system 100 can include or be coupled with one or more components of a VMS, such as to provide video data in response to a request provided to the VMS.

The system 200 can include the requestor 102 and the data source 104 as described above. The system 200 can include or be coupled to one or more of the demultiplexer 202 and the parser 204. The demultiplexer 202 can separate information from the video footage such as the video data, audio, and subtitles provided by the data source 104. The demultiplexer 202 can output a plurality of bitstreams. For example, the demultiplexer 202 can output the video data as a first bitstream and the audio of the video footage as a second bitstream. For example, the demultiplexer 202 can receive an MP4 video footage file, separate a H.264 video stream and an AAC audio stream, and send the streams to be decoded.

The parser 204 can provide data and information to the demultiplexer 202. The parser 204 can read, interpret, and extract metadata and structural information from the video footage while the demultiplexer 202 can use information provided by the parser 204 to separate and output bitstreams from the video footage to be processed. The parser 204 can drop GOPs and frames that follow the end position.

The system 200 can include or be coupled to one or more GOP detectors 206. The GOP detector 206 can receive the requested start position (e.g., 0:30) and end position (e.g., 1:30) from the requestor 102 and detect a GOP 208 corresponding to the start position. The GOP detector 206 can receive timestamp and time information in a bitstream from the demultiplexer 202 and the parser 204 to determine the GOP 208 corresponding to the start position. The GOP 208 corresponding to the start position can include a first key frame (e.g., IDR). The GOP 208 can include a plurality of P-frames following a first key frame. The first key frame of the GOP 208 may be prior to or at the requested start position. A first GOP 208 boundary can include the requested start position and the first key frame corresponding to the start position. A second GOP 208 boundary can be a second key frame (e.g., the next key frame following the first key frame corresponding to the start position). The second key frame can be prior to the requested end position.

The system 200 can include or be coupled to one or more transcoders 210. The transcoder 210 can include the decoder 112 and the encoder 116. The transcoder 210 can receive the GOP 208 including the start position from the GOP detector 206. The transcoder 210 can feed the GOP 208 including the start position to the decoder 112 to decode the GOP 208. The decoder 112 can decode the GOP 208 from the first boundary to the second boundary of the GOP 208. The decoder 112 can provide the encoder 116 with the GOP 208. The encoder 116 can encode the GOP 208 from the first boundary to the second boundary with encoding parameters that match the encoding parameters of the GOP 208 prior to decoding. The encoder 116 can provide the encoded GOP 208 to the multiplexer 212.

The system can include or be coupled to one or more multiplexers 212. The multiplexer 212 can use time division multiplexing (TDM) to retain timing information and time stamps of the video data segment. The multiplexer 212 can combine (e.g., multiplex) the bitstream data received from the encoder 116 into a container format. The container format can synchronize the bitstreams in a single file. The container format can include MP4, MKV, and AVI. The multiplexer 212 can perform a function opposite and/or reverse a function of the demultiplexer 202.

The multiplexer 212 can be coupled to the GOP detector 206 and the encoder 116. The GOP detector 206 can provide the multiplexer 212 with GOPs of the video data segment corresponding to the start position and the end position that do not correspond to the start position. The encoder 116 can provide the multiplexer 212 with the GOP 208 including the start position. The multiplexer 212 can combine (e.g., append) the GOPs of the video data segment from the GOP detector 206 with the GOP 208. The GOPs from the GOP detector 206 are not decoded or encoded, and can be directly appended to the GOP 208 including the start position following decoding and encoding of the GOP 208. The GOP 208 can have the same encoding parameters as the GOPs from the GOP detector 206. The GOPs from the GOP detector 206 can include GOPs following the GOP including the start position and end with a GOP including the end position. The multiplexer 212 can generate the requested video data segment starting at the start position and ending at the end position. The multiplexer 212 can combine the bitstreams of the GOP 208 received from the encoder 116 and the GOP detector 206 into a single multiplexed stream of the requested start position and end position of the video data.

The system 200 can include or be coupled to one or more sinks 214. The sink 214 can be coupled to the multiplexer 212. The sink 214 can receive the video data segment from the multiplexer 212 and save (e.g., store) the output of the multiplexer 212 into the single file. The sink 214 can save the container format of the video data segment with the requested start position and the end position. The file can then be sent to the requestor 102. The sink 214 can include a display device (e.g., monitor, TV) and storage systems (e.g., a database). The sink 214 can be coupled to the requestor 102 and the sink 214 can return the requested video data segment to the requestor 102.

In some implementations, the second key frame can correspond to the requested end position. For example, if the first GOP 208 boundary corresponds to the requested start position, and the second GOP 208 boundary corresponds to the requested end position, the GOP 208 can be transcoded and output by the sink 214 to the requestor 102 without appending additional video data (e.g., the second video output).

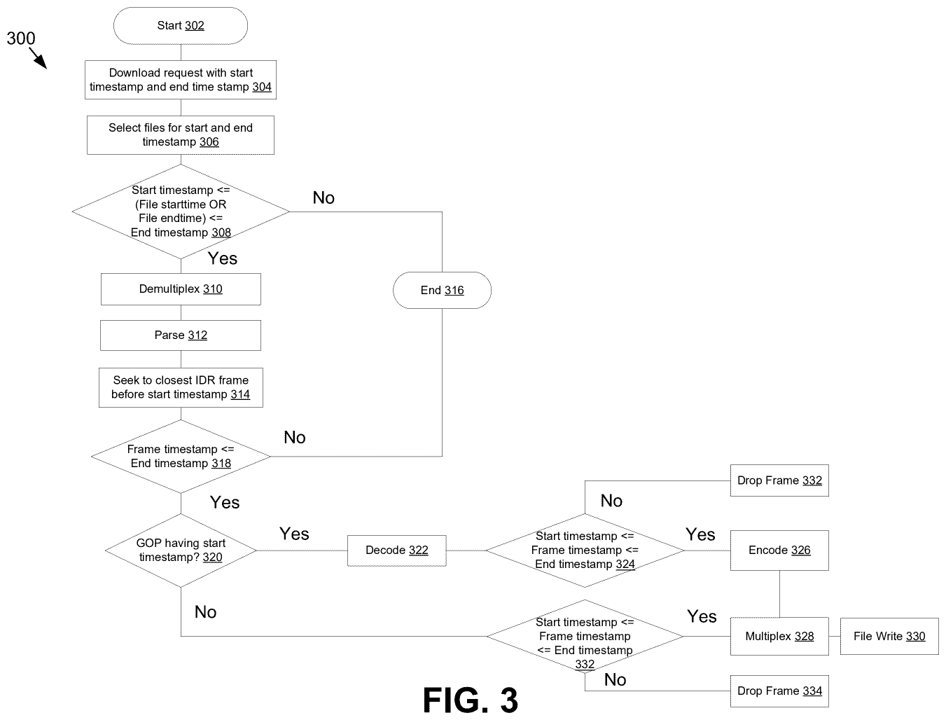

FIG. 3 is a block diagram of an example method 300 to concatenate video data with selective transcoding which can be implemented by the system 100 and the system 200. Each block of method 300, described herein, includes a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system 100 and the system 200 of FIGS. 1 and 2. However, the method 300 may additionally or alternatively be executed by any one system, or any combination of systems, including, but not limited to, those described herein.

The method 300 at block 302 includes an initialization (e.g., start) request. For example, a request from the requestor 102 can be received to initialize the method 300.

The method 300 at block 304 includes downloading a request with a start timestamp and an end timestamp. For example, the requestor 102 can receive a request with a desired start timestamp and an end timestamp of a video data. At block 304, the request with the start timestamp and the end timestamp can be downloaded and input into the method 300.

The method 300 at block 306 includes selecting file(s) for the start and end timestamps. For example, as seen in FIG. 1, the extractor 108 can extract the video data including the start and end timestamps from the data source 104. Video data including the requested start and end timestamps can be selected and received.

The method 300 at block 308 includes checking whether the selected file includes the start timestamp and end timestamp. This can include, for example, checking whether or not the selected file (e.g., the video data) has a file start time or file end time greater than or equal to the requested start timestamp, and if the file start time or file end time is less than or equal to the end timestamp. Responsive to the file start time or the file end time being within the requested start timestamp and the end timestamp, the selected file can be further processed, e.g., to be demultiplexed.

At block 310, the selected file is demultiplexed. The selected file is separated into bitstreams of data to be processed further.

At block 312, the selected file is parsed. This can include parsing through the selected file and reading the video data within the selected file and, at block 314, the closest key frame (e.g., IDR frame) to the requested start timestamp can be sought. The closest key frame (e.g., the first key frame) can be prior to the requested start timestamp. At block 318, the first key frame is checked for whether or not the first key frame is less than or equal to the requested end timestamp.

At block 308, responsive to the file start time or the file end time not being within the requested start timestamp and the end timestamp, the method 300 can be ended at block 316. Responsive to the first key frame not being less than or equal to the requested end timestamp at block 318, the method 300 can be ended at block 316. From block 316, the method 300 can reinitialize at block 306 to start again.

Responsive to the first key frame being less than or equal to the requested end timestamp at block 318, the method 300 can move to block 320 to determine whether or not the GOP includes the start timestamp. The method 300 first checks whether or not the first key frame is less than or equal to the end timestamp at block 318 before checking whether a selected GOP includes the start timestamp. Responsive to the GOP including the start timestamp, the GOP can be decoded at block 322.

The GOP including the start timestamp can be decoded at block 322. At block 324, it can be determined whether the plurality of frames within the GOP is within the requested start timestamp and end timestamp. Responsive to the plurality of frames being within the requested start timestamp and end timestamp, the GOP can be encoded at block 326, and can be multiplexed at block 328. Responsive to the plurality of frames not being within the requested start timestamp and end timestamp, the frames can be dropped from the video file at block 332. For example, the GOP can be decoded, encoded, and multiplexed in system 200 as seen in FIG. 2.

Responsive to the GOP not including the requested start time, at block 332 it can be determined whether not the plurality of frames within the GOP is within the requested start timestamp and end timestamp. Responsive to the plurality of frames not being within the requested start timestamp and end timestamp, the frames can be dropped at block 334. Responsive to the plurality of frames being within the requested start timestamp and end timestamp, the plurality of frames within the GOP that does not include the requested start time can be multiplexed at block 328. At block 328, the GOP including the start timestamp, and a plurality of GOPs not including the start timestamp can be combined (e.g., multiplexed).

Responsive to multiplexing at block 328, the video file is written and saved at block 330. The video file begins at the requested start timestamp and ends at the requested end timestamp.

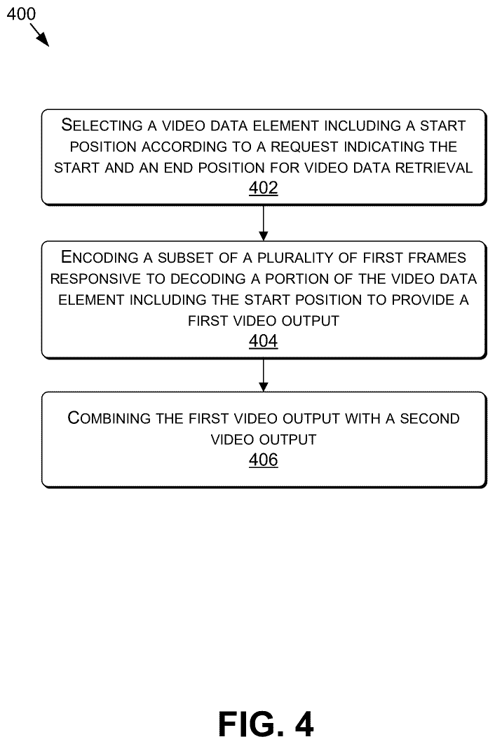

Now referring to FIG. 4, each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

FIG. 4 is a flow diagram showing the method 400 for concatenating video data with selective transcoding, in accordance with some implementations of the present disclosure. The method 400, at block 402, includes selecting a video data element including a start position according to a request indicating the start and an end position for video data retrieval. For example, upon receiving input information from the requestor 102, the method 400 can include selecting the video data element including the start position from the data source 104. The selected video data element can also include the end position. At block 404, the method 400 includes encoding a subset of a plurality of first frames responsive to decoding a portion of the video data element including the start position to provide a first video output. For example, following selection of the video data element at block 402, the decoder 112 can decode a portion of the video data element including the start position followed by the encoder 116 encoding the portion that was decoded. The portion of the video data element can be the first video output.

The method 400, at block 406, can include combining the first video output with a second video output. The second video output can include one or more second frames of the video data up until the end position. For example, the second video output can skip decoding and encoding and be appended to the first video output. The first video output can be encoded according to encoding parameters of the second video output so that the second video output can be directly combined (e.g., appended) to the first video output. The method 400 can allow for reduced hardware usage and increased video selection accuracy by selectively transcoding the portion of the video data element with the start position.

### EXAMPLE CONTENT STREAMING SYSTEM

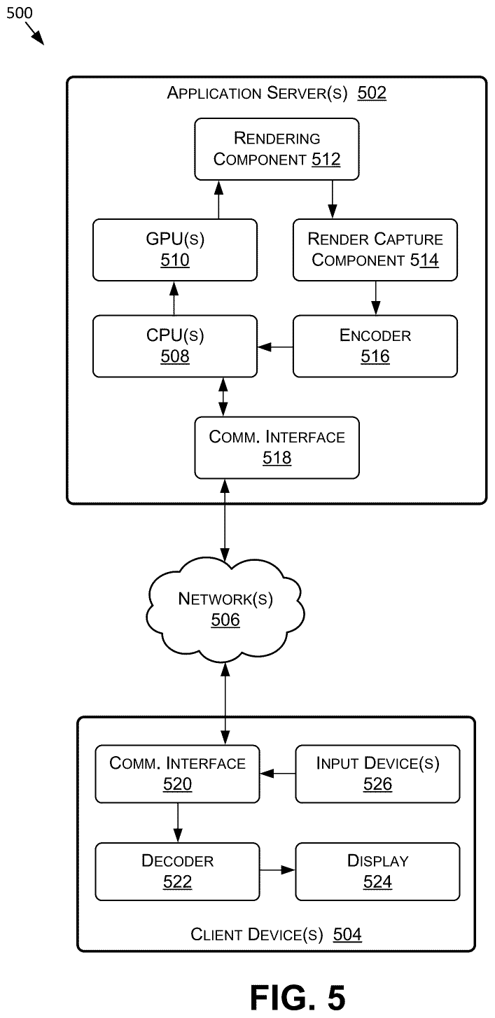

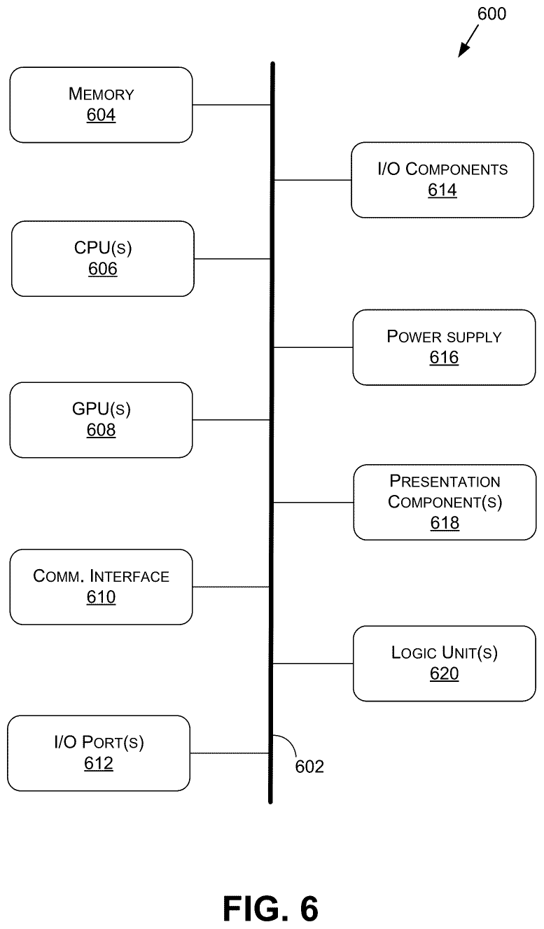

Now referring to FIG. 5, FIG. 5 is an example system diagram for a content streaming system 500, in accordance with some implementations of the present disclosure. FIG. 5 includes application server(s) 502 (which may include similar components, features, and/or functionality to the example computing device 600 of FIG. 6), client device(s) 504 (which may include similar components, features, and/or functionality to the example computing device 600 of FIG. 6), and network(s) 506 (which may be similar to the network(s) described herein). In some implementations of the present disclosure, the system 500 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 500, for an application session, the client device(s) 504 may only receive input data in response to inputs to the input device(s), transmit the input data to the application server(s) 502, receive encoded display data from the application server(s) 502, and display the display data on the display 524. The input data may include a requested start position and end position of the input data which may be video data. As such, the more computationally intense computing and processing is offloaded to the application server(s) 502 (e.g., rendering—in particular ray or path tracing-for graphical output of the application session is executed by the GPU(s) of the game server(s) 502). In other words, the application session is streamed to the client device(s) 504 from the application server(s) 502, thereby reducing the requirements of the client device(s) 504 for graphics processing and rendering.

For example, with respect to an instantiation of an application session, a client device 504 may be displaying a frame of the application session on the display 524 based on receiving the display data from the application server(s) 502. The client device 504 may display a video and/or images with the requested start timestamp and end timestamp. The client device 504 may receive an input to one of the input device(s) and generate input data in response. The client device 504 may transmit the input data to the application server(s) 502 via the communication interface 520 and over the network(s) 506 (e.g., the Internet), and the application server(s) 502 may receive the input data via the communication interface 518. The CPU(s) may receive the input data, process the input data, and transmit data to the GPU(s) that causes the GPU(s) to generate a rendering of the application session. For example, and without limitation, the input data may be representative of a movement of a character of the user in a game session of a game application, firing a weapon, reloading, passing a ball, and turning a vehicle. The rendering component 512 may render the application session (e.g., representative of the result of the input data) and the render capture component 514 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 502. In some implementations, one or more virtual machines (VMs)—e.g., including one or more virtual components, such as, and without limitation vGPUs and vCPUs—may be used by the application server(s) 502 to support the application sessions. The encoder 516 may then encode the video and/or display data to generate encoded display data and the encoded display data may be transmitted to the client device 504 over the network(s) 506 via the communication interface 518. The client device 504 may receive the encoded display data via the communication interface 520 and the decoder 522 may decode the encoded display data to generate the display data. The client device 504 may then display the display data via the display 524.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g. and without limitation ray-tracing and path tracing), collaborative content creation for 3D assets, cloud computing and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### EXAMPLE COMPUTING DEVICE

FIG. 6 is a block diagram of an example computing device(s) 600 suitable for use in implementing some implementations of the present disclosure. The computing device 600 can implement the system 100, the system 200, the method 300, and the method 400 as discussed above. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g. and without limitation one, two, four, eight, twenty-eight, seventy-two) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co- processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In implementations, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In implementations, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g. and without limitation Wi-Fi, Z-Wave, Bluetooth, Bluetooth LE, ZigBee), wired networks (e.g., communicating over Ethernet or InfiniBand), low-power wide- area networks (e.g. and without limitation LoRaWAN, SigFox), and/or the Internet. In one or more implementations, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include, and without limitation, a microphone, mouse, keyboard, joystick, game pad, game controller, satellite dish, scanner, printer, and a wireless device. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. For example, the requestor 102 may include the presentation component(s) 618. The presentation component(s) 618 may receive data from other components (e.g. and without limitation the GPU(s) 608, the CPU(s) 606, and DPUs), and output the data (e.g. and without limitation as an image, video, sound). For example, the presentation component(s) 618 may receive data from the combiner 120 and/or the sink 214.

### EXAMPLE DATA CENTER

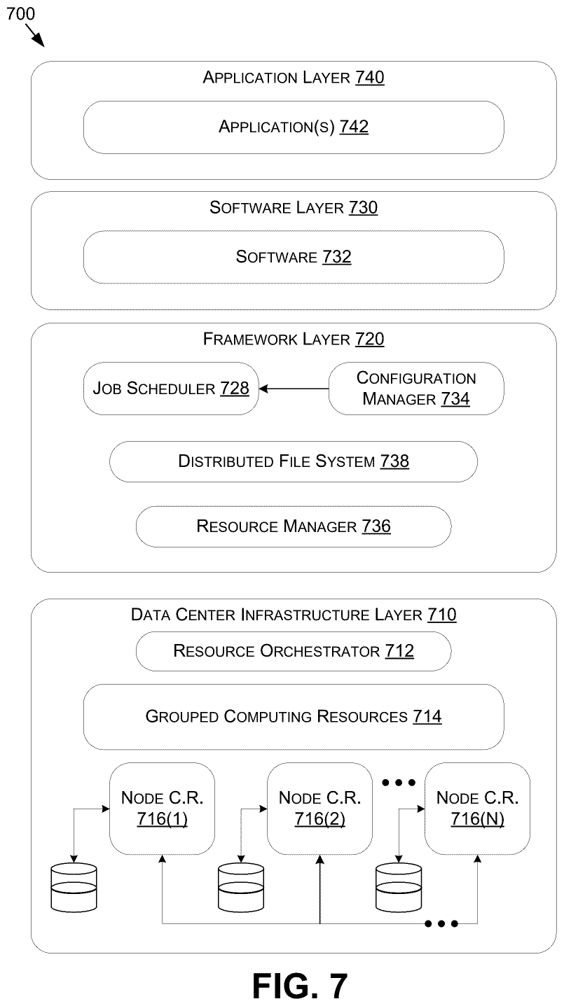

FIG. 7 illustrates an example data center 700 that may be used in at least one implementations of the present disclosure. The data center 700 may include a data center infrastructure layer 710, a framework layer 720, a software layer 730, and/or an application layer 740. The data center 700 may include the video data and image data. The data center 700 may include the data source 104. The data center 700 may include video and image data from security cameras, vehicle cameras, and/or any other various cameras. The data center 700 may be coupled to a video management system (VMS).

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one implementation, node C.R.s 716(1)-716(N) may include, but are not limited to, any number of central processing units (CPUs) or other processors (including, and without limitation, DPUs, accelerators, field programmable gate arrays (FPGAs), and graphics processors or graphics processing units (GPUs)), memory devices (e.g., dynamic read-only memory), storage devices (e.g., solid state or disk drives), network input/output (NW I/O) devices, network switches, virtual machines (VMs), power modules, and/or cooling modules. In some implementations, one or more node C.R.s from among node C.R.s 716(1)-716(N) may correspond to a server having one or more of the above-mentioned computing resources. In addition, in some implementations, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one implementation, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one implementation, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one implementation, resource orchestrator 712 may include a software design infrastructure (SDI) management entity for the data center 700. The resource orchestrator 712 may include hardware, software, or some combination thereof.

In at least one implementation, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one implementation, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one implementation, clustered or grouped computing resources may include grouped computing resource 714 at data center infrastructure layer 710. The resource manager 736 may coordinate with resource orchestrator 712 to manage these mapped or allocated computing resources.

In at least one implementation, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one implementation, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g. and without limitation PyTorch, TensorFlow, Caffe), and/or other machine learning applications used in conjunction with one or more implementations.

In at least one implementation, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 700. In at least one implementation, trained or deployed machine learning models corresponding to one or more neural networks may be used to infer or predict information using resources described above with respect to the data center 700 by using weight parameters calculated through one or more training techniques, such as but not limited to those described herein.

In at least one implementation, the data center 700 may use CPUs, application- specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g. and without limitation servers, NAS) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include, but not limited to, one or more cloud-based network environments, a distributed computing environment, a combination thereof. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g. and without limitation of one or more data centers that may be distributed across a state, a region, a country, the globe). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including, but not limited to, routines, programs, objects, components, and data structures, refer to code that perform particular tasks or implement particular abstract data types. The disclosure may be practiced in a variety of system configurations, including, but not limited to, hand-held devices, consumer electronics, general- purpose computers, and more specialty computing devices. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
select, according to a request that indicates a start position and an end position for retrieval of video data, a video data element comprising the start position;
encode, responsive to decoding a portion of the video data element that comprises the start position, a subset of a plurality of first frames of the video data element comprising (i) one of the plurality of first frames corresponding to the start position and (ii) each first frame of the plurality of first frames following the one of the plurality of first frames until a key frame of the video data element, to provide a first video output; and
combine the first video output with a second video output comprising one or more second frames of the video data up to the end position for the video data.

2. The one or more processors of claim 1, wherein the one or more circuits are to combine the first video output with the second video output by providing, to a multiplexer, the first video output and the second video output without decoding the second video output.

3. The one or more processors of claim 1, wherein the key frame is a second key frame, and the video data element comprises a first key frame prior to the plurality of first frames, wherein the one or more circuits are to skip encoding of each first frame of the plurality of first frames between the first key frame and the one of the plurality of first frames corresponding to the start position.

4. The one or more processors of claim 1, wherein the one or more circuits are to encode the subset of the plurality of first frames according to one or more encoding parameters by which frames of the second video output are encoded.

5. The one or more processors of claim 1, wherein the one or more circuits are to discard from inclusion in the first video output and the second video output any one or more frames of the video data element subsequent to the end position.

6. The one or more processors of claim 1, wherein the video data element comprises a plurality of groups of pictures (GOPs), the plurality of first frames is of a first GOP of the plurality of GOPs, and the key frame is of a second GOP of the plurality of GOPs subsequent to the first GOP.

7. The one or more processors of claim 1, wherein the one or more processors are comprised in at least one of:
a system for performing deep learning operations;
a system for performing simulation operations;
a system for performing collaborative content creation for 3D assets;
a system for generating synthetic data;
a system for performing digital twin operations;
a control system for an autonomous or semi-autonomous machine;
a perception system for an autonomous or semi-autonomous machine;
a system incorporating one or more virtual machines (VMs);
a system implemented using a robot;
a system implemented using an edge device;
a system comprising one or more vision language models (VLMs);
a system comprising one or more large language models (LLMs);
a system for performing conversational AI operations;
a system for performing light transport simulation;
a system implemented at least partially in a data center; or
a system implemented at least partially using cloud computing resources.

8. A system comprising:
one or more processing units; and
one or more memory units storing instructions that, when executed by the one or more processing units, cause the one or more processing units to execute operations comprising:
selecting, according to a request that indicates a start position and an end position for retrieval of video data, a video data element comprising the start position;
encoding, responsive to decoding a portion of the video data element that comprises the start position, a subset of a plurality of first frames of the video data element comprising (i) one of the plurality of first frames corresponding to the start position and (ii) each first frame of the plurality of first frames following the one of the plurality of first frames until a key frame of the video data element, to provide a first video output; and
combining the first video output with a second video output comprising one or more second frames of the video data up to the end position for the video data.

9. The system of claim 8, wherein the one or more processing units are to combine the first video output with the second video output by providing, to a multiplexer, the first video output and the second video output without decoding the second video output.

10. The system of claim 8, wherein the key frame is a second key frame, and the video data element comprises a first key frame prior to the plurality of first frames, wherein the one or more processors are to skip encoding of each first frame of the plurality of first frames between the first key frame and the one of the plurality of first frames corresponding to the start position.

11. The system of claim 8, wherein the one or more processing units are to encode the subset of the plurality of first frames according to one or more encoding parameters by which frames of the second video output are encoded.

12. The system of claim 8, wherein the one or more processing units are to discard from inclusion in the first video output and the second video output any one or more frames of the video data element subsequent to the end position.

13. The system of claim 8, wherein the video data element comprises a plurality of groups of pictures (GOPs), the plurality of first frames is of a first GOP of the plurality of GOPs, and the key frame is of a second GOP of the plurality of GOPs subsequent to the first GOP.

14. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or a system implemented at least partially using cloud computing resources.

15. A method comprising:
selecting, according to a request that indicates a start position and an end position for retrieval of video data, a video data element comprising the start position;
encoding, responsive to decoding a portion of the video data element that comprises the start position, a subset of a plurality of first frames of the video data element comprising (i) one of the plurality of first frames corresponding to the start position and (ii) each first frame of the plurality of first frames following the one of the plurality of first frames until a key frame of the video data element, to provide a first video output; and
combining the first video output with a second video output comprising one or more second frames of the video data up to the end position for the video data.

16. The method of claim 15, wherein the first video output is combined with the second video output by providing, to a multiplexer, the first video output and the second video output without decoding the second video output.

17. The method of claim 15, wherein the key frame is a second key frame, and the video data element comprises a first key frame prior to the plurality of first frames and encoding skips each first frame of the plurality of first frames between the first key frame and the one of the plurality of first frames corresponding to the start position.

18. The method of claim 15, wherein encoding the subset of the plurality of first frames is according to one or more encoding parameters by which frames of the second video output are encoded.

19. The method of claim 15, wherein any one or more frames of the video data element subsequent to the end position in the first video output and the second video output are discarded from inclusion position in the first video output and the second video output.

20. The method of claim 15, wherein the video data element comprises a plurality of groups of pictures (GOPs), the plurality of first frames is of a first GOP of the plurality of GOPs, and the key frame is of a second GOP of the plurality of GOPs subsequent to the first GOP.
